(19) United States
(12) Patent Application Publication
(10) Pub. No.: US 2024/0320404 A1
(43) Pub. Date: Sep. 26, 2024

(54) DESIGN SUPPORT DEVICE, DESIGN SUPPORT METHOD, AND STORAGE MEDIUM

(71) Applicant: HONDA MOTOR CO., LTD., Tokyo (JP)

(72) Inventors: Sho Nakajima, Wako-shi (JP); Atsushi Yamamoto, Wako-shi (JP); Jun Okano, Wako-shi (JP)

(21) Appl. No.: 18/582,696

(22) Filed: Feb. 21, 2024

(30) Foreign Application Priority Data
Mar. 20, 2023 (JP) 2023-044230

(51) Int. Cl. G06F 30/27

(52) U.S. Cl. CPC G06F 30/27

(57) ABSTRACT

A design support device includes a processor configured to execute a program to estimate a plurality of types of performance of a product from a design factor group including a plurality of design factors of the product using a machine learning model, and generate candidates for design information of the product on the basis of comprehensive evaluation of the estimated plurality of types of performance. The processor is further configured to execute the program to acquire Pareto solutions to the plurality of types of performance as the candidates for design information using a genetic algorithm with the plurality of design factors as chromosome information.

### CROSS-REFERENCE TO RELATED APPLICATION

Priority is claimed on Japanese Patent Application No. 2023-044230, filed Mar. 20, 2023, the content of which is incorporated herein by reference.

### BACKGROUND OF THE INVENTION

### Field of the Invention

The present invention relates to a design support device, a design support method, and a storage medium.

### Description of Related Art

In design of a product, techniques of ascertaining a relationship between design factors indicating materials or design items of the product and performance of the product and determining specifications of the product such that desired performance is realized are known.

When certain design factors (which correspond to “explanatory variables”) are changed, it is not easy to ascertain how a plurality of types of performance (which correspond to “objective variables”) defined from various viewpoints will be affected. Accordingly, techniques of producing products with several specifications (products with different design factors) by trial on the basis of results of single regression analysis of design factors and experience of a designer and ascertaining performance of the products are carried out in the related art. In these techniques according to the related art, when performance under goals is ascertained, it is necessary to make a trial product again while adjusting the design factors. Even when specific performance achieves a goal through the second trial production, other performance is likely to decrease therethrough. Even when all types of performance achieve goals, it is not possible to ascertain whether it is the best. For example, in Japanese Unexamined Patent Application, First Publication No. 2011-187056, it is proposed that design optimization is performed using a multi-objective evolutionary algorithm on the basis of the premise of engineering design that a relationship between design factors and objective variables is apparent, but it is not possible to optimize design of a product in which a relationship between explanatory variables and objective variables is unknown.

### SUMMARY OF THE INVENTION

An embodiment of the present invention was made in consideration of the aforementioned circumstances, and an objective thereof is to provide a design support device, a design support method, and a storage medium that can support optimization of design of a product.

A design support device, a design support method, and a storage medium according to the present invention employ the following configurations.
(1) A design support device according to an aspect of the present invention includes a processor configured to execute a program to estimate a plurality of types of performance of a product from a design factor group including a plurality of design factors of the product using a machine learning model, and generate candidates for design information of the product on the basis of comprehensive evaluation of the estimated plurality of types of performance. The processor is further configured to execute the program to acquire Pareto solutions to the plurality of types of performance as the candidates for design information using a genetic algorithm with the plurality of design factors as chromosome information.
(2) In the design support device according to the aspect of (1), the processor is further configured to execute the program to calculate fitness indicating the comprehensive evaluation on the basis of the estimated plurality of types of performance, and acquire the Pareto solutions on the basis of the calculated fitness.
(3) In the design support device according to the aspect of (1), the processor is further configured to execute the program to select the design factor group of a next generation from a plurality of the design factor groups of a certain generation on the basis of the calculated fitness.
(4) In the design support device according to the aspect of (3), the processor is further configured to execute the program to select a design factor group including outliers in the plurality of types of performance as the design factor group of the next generation from the plurality of design factor groups of the certain generation.
(5) In the design support device according to the aspect of (3) or (4), the processor is configured to execute the program to generate the design factor group of the next generation by causing at least one of crossing-over and mutation in the selected design factor group.
(6) In the design support device according to any one of the aspects of (2) to (4), the processor is configured to execute the program to calculate the fitness by summing numerical values of the estimated plurality of types of performance.
(7) In the design support device according to any one of the aspects of (2) to (4), the processor is configured to execute the program to calculate the fitness by summing values obtained by multiplying numerical values of the estimated plurality of types of performance by weights.
(8) In the design support device according to any one of the aspects of (1) to (4), the processor is configured to execute the program to estimate the plurality of types of performance from the design factor group satisfying constraint conditions based on characteristics of the product.
(9) In the design support device according to any one of the aspects of (1) to (4), the machine learning model is a model that is trained to output estimated values of the plurality of types of performance when the design factor group is input.
(10) In the design support device according to any one of the aspects of (1) to (4), the product is a battery.
(11) A design support method according to another aspect of the present invention is a design support method that is performed by a computer, the design support method including: estimating a plurality of types of performance of a product from a design factor group including a plurality of design factors of a product using a machine learning model; and generating candidates for design information of the product on the basis of comprehensive evaluation of the estimated plurality of types of performance, wherein the generating of candidates for design information of the product includes acquiring Pareto solutions to the plurality of types of performance as the candidates for design information using a genetic algorithm with the plurality of design factors as chromosome information.
(12) A non-transitory computer-readable storage medium according to another aspect of the present invention stores a program for causing a computer to perform: estimating a plurality of types of performance of a product from a design factor group including a plurality of design factors of a product using a machine learning model; and generating candidates for design information of the product on the basis of comprehensive evaluation of the estimated plurality of types of performance, wherein the generating of candidates for design information of the product includes acquiring Pareto solutions to the plurality of types of performance as the candidates for design information using a genetic algorithm with the plurality of design factors as chromosome information.

With the configurations according to the aspects of (1) to (12), it is possible to support optimization of product design. Particularly, it is possible to optimize design of a product in which relationships between a plurality of design factors (explanatory variables) and a plurality of types of performance (objective variables) are unknown.

With the configurations according to the aspects of (2) to (7), it is possible to ascertain candidates for design information that uniformly achieve a plurality of types of performance using fitness for comprehensive evaluation of the plurality of types of performance.

With the configuration according to the aspect of (9), it is possible to narrow a range of design factors of a product to a realizable range by applying constraint conditions to a plurality of design factors (explanatory variables) to be designed and to achieve efficient design.

### BRIEF DESCRIPTION OF THE DRAWINGS

FIG. 1 is a block diagram schematically showing an example of a configuration of a design support device according to an embodiment.

FIG. 2 is a diagram showing an example of input/output data of a machine learning model according to the embodiment.

FIG. 3 is a block diagram schematically showing an example of a hardware configuration of the design support device according to the embodiment.

FIG. 4 is a flowchart showing an example of a process flow that is performed by the design support device according to the embodiment.

FIG. 5 is a diagram showing an example of data that is generated through processes performed by the design support device according to the embodiment.

FIG. 6 is a diagram showing an individual selecting process based on fitness according to the embodiment.

FIG. 7 is a diagram showing an individual selecting process in consideration of diversity according to the embodiment.

### DETAILED DESCRIPTION OF THE INVENTION

A design support device, a design support method, and a storage medium according to an embodiment of the present invention will be described below with reference to the accompanying drawings.

### <Configuration of Design Support Device 10>

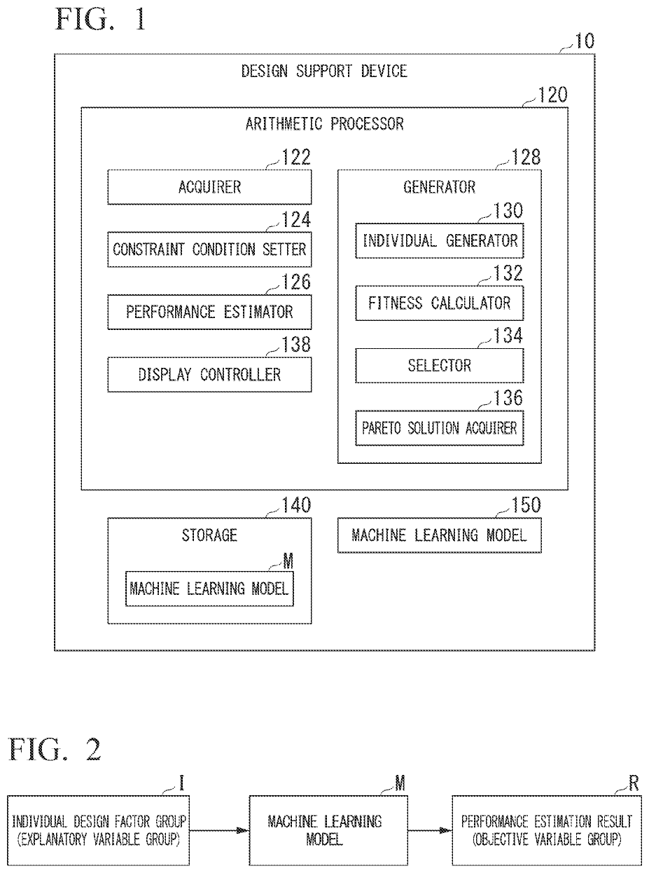

FIG. 1 is a block diagram schematically showing an example of a configuration of a design support device 10 according to an embodiment. The design support device 10 can support design optimization in comprehensive consideration of a plurality of types of performance which are goals in design of a product. The design support device 10 can ascertain high-order Pareto optimal solutions to the plurality of types of performance satisfying target criteria and information of design factors associated therewith even when relationships between a plurality of design factors (which correspond to “explanatory variables”) and a plurality of types of performance (which correspond to “objective variables”) of a product are unknown by combining a technique based on a machine learning algorithm and a technique based on a genetic algorithm.

This embodiment can be applied to a product having dependency on production requirements such as materials or design items. This embodiment can be applied to, for example, a battery (also referred to as a storage battery or a secondary battery of which repeated charging and discharging are possible) as such a product. When a product to be processed is a battery, an explanatory variable group includes some or all items such as electrode materials (material design), mixture ratios (production-engineering design) of a plurality of types of materials, an electrode length, and an electrode thickness (shape). As indices of performance given to the explanatory variable group, for example, capacity, output, cost, and the like are used as objective variables. Capacity corresponds to electric charge which is discharged after discharging has been started when an output voltage between both electrodes is a rated voltage and before the output voltage reaches a final voltage. Output corresponds to a current or electric power which is obtained through discharging when the output voltage is equal to the rated voltage. Cost is production cost of the product. The cost may include overhead expenses required for processing, distribution, and the like in addition to unit prices of individual members.

The design support device 10 includes, for example, an arithmetic processor 120, a storage 140, and an input/output unit 150. The arithmetic processor 120 includes, for example, an acquirer 122, a constraint condition setter 124, a performance estimator 126, a generator 128, and a display controller 138.

The acquirer 122 acquires product data indicating characteristics of individual products. The product data includes a plurality of data sets. Each data set includes production information (design data) and performance information. The production information includes one or more variables (design factors) indicating information on one or both of materials and design items of a product. The performance information includes one or more measurement values of performance of a product which is produced on the basis of the production information included in data sets common to the performance information. That is, the product data includes a plurality of data sets which are sets of explanatory variables indicating materials or design items of a product and objective variables indicating performance of the product.

For example, the acquirer 122 acquires product data from a predetermined external device. The external device is, for example, a database, a server unit, a personal computer, or a dedicated measuring instrument which stores the product data. The acquirer 122 may acquire the product data which is input by a user via an operation input unit 158 which will be described later. Alternatively, the product data may be stored in a detachable storage medium such as a USB, a DVD, or a CD-ROM, and the acquirer 122 may acquire the product data by setting the storage medium into a drive device of the design support device 10.

The constraint condition setter 124 sets a realizable design range (constraint conditions) based on characteristics of a product (for example, production conditions). For example, the constraint condition setter 124 sets the constraint conditions on the basis of an instruction which is input by a user via the operation input unit 158. The constraint conditions include, for example, production conditions such as materials of members (material design) used for production of a product, mixture ratios (production-engineering design) of a plurality of types of materials, and a shape.

The performance estimator 126 estimates a plurality of types of performance of a product from a design factor group including a plurality of design factors based on design data of the product using a trained machine learning model M stored in the storage 140. FIG. 2 is a diagram showing an example of input/output data of the machine learning model M according to the embodiment. As shown in FIG. 2, the machine learning model M is trained to output performance estimation results R (an objective variable group) of the plurality of types of performance when a design factor group (an explanatory variable group) is input thereto. The performance estimator 126 acquires the performance estimation results R corresponding to individuals by inputting design factor groups (also referred to as “individuals I”) generated by the generator 128 to the machine learning model M.

Types of the machine learning model M are roughly classified into, for example, a model associated with linear regression and a model associated with nonlinear regression. Linear regression is a statistical technique of clarifying a relationship between the explanatory variables and the objective variables on the basis of the assumption that a model representing the relationship is a linear estimation function. In this embodiment, regression analysis techniques such as multiple regression analysis, ridge regression, least absolute shrinkage and selection operator (LASSO) regression, and elastic net can be used as the technique associated with linear regression. Nonlinear regression is a statistical technique of clarifying a nonlinear relationship between the explanatory variables and the objective variables using a mathematical model indicating the nonlinear relationship. Known techniques such as support vector machine (SVR), neural network, Adaboost, gradient boosting, and random forest can be used as the mathematical model associated with nonlinear regression.

The generator 128 generates candidates for design information of a product satisfying predetermined performance requirements using a genetic algorithm with a plurality of design factors as chromosome information on the basis of comprehensive evaluation of the plurality of types of performance estimated by the performance estimator 126. The generator 128 includes, for example, an individual generator 130, a fitness calculator 132, a selector 134, and a Pareto solution acquirer 136.

The individual generator 130 generates a plurality of individuals corresponding to chromosome information. When initial individuals are generated, the individual generator 130 generates a plurality of individuals on the basis of product data acquired by the acquirer 122 and/or constraint conditions set by the constraint condition setter 124. For example, the individual generator 130 generates a plurality of individuals having values which are between upper limits and lower limits of the design factors in the acquired product data and which satisfy the set constraint conditions as the initial individuals. The plurality of individuals have different design factors. When individuals of a second generation or a generation subsequent thereto are generated, the individual generator 130 generates a plurality of individuals by causing at least one of crossing-over and mutation of explanatory variables in the individuals selected by the selector 134. The crossing-over includes, for example, uniform crossing-over (discrete values) or simulated binary crossover (SBX) (continuous values). The mutation includes, for example, list selection (discrete values) or polynomial mutation (PM) (continuous values).

The fitness calculator 132 calculates fitness indicating comprehensive evaluation of a plurality of types of performance on the basis of estimated values of the plurality of types of performance (performance estimation results R) estimated by the performance estimator 126. The fitness is an index value indicating superiority (optimality) of the individuals when balanced achievement of the plurality of types of performance is a goal. The fitness calculator 132 calculates the fitness, for example, on the basis of Expression (1).

$$Fitness = {ω}_{1} \cdot {performance}_{1} + {ω}_{2} \cdot {performance}_{2} + … + {ω}_{n} \cdot {performance}_{n} . \qquad Expression ( 1 )$$

In Expression (1), “performance,” is a numerical value of performance defined for each individual. When the product is a battery, for example, numerical values of capacity, output, performance, and cost are set in “performanceₙ.” “ωₙ” is a weighting factor. “ωₙ” is set, for example, on the basis of an instruction from a user via the operation input unit 158. A user can set significant types of performance at the time of design of the product. The weighting factor on may not be set. In this case, a summed value (a comprehensive score) of “performanceₙ” is the fitness. In addition, an arbitrary calculation formula (such as a multiplied value) may be employed to calculate the fitness as long as it is based on “performanceₙ.”

That is, the fitness calculator 132 calculates the fitness by summing numerical values of the estimated plurality of types of performance. Alternatively, the fitness calculator 132 calculates the fitness by summing values obtained by multiplying the numerical values of the estimated plurality of types of performance by weights.

The selector 134 selects a design factor group (candidates) of a next generation from a plurality of design factor groups of a certain generation on the basis of the fitness calculated by the fitness calculator 132. The selector 134 selects a design factor group including outliers in the plurality of types of performance as the design factor group (candidates) of the next generation out of the plurality of design factor groups of the certain generation. Details of the process performed by the selector 134 will be described later.

The Pareto solution acquirer 136 acquires Pareto solutions of the plurality of types of performance including design factor information as candidates for design information using a genetic algorithm with a plurality of design factors as chromosome information. The Pareto solution acquirer 136 acquires a plurality of types of performance corresponding to a predetermined number of individuals with higher fitness as Pareto solutions out of individuals of an n-th generation satisfying ending conditions. Details of the process performed by the Pareto solution acquirer 136 will be described later.

The display controller 138 causes a display 160 to display a screen for notifying a user of various types of information, a graphical user interface (GUI) for receiving various input operations from a user, or the like. For example, the display controller 138 causes the display 160 to display a screen including information of the Pareto solutions acquired by the Pareto solution acquirer 136, a screen for receiving an input operation of constraint conditions, or the like.

The storage 140 stores various types of data temporarily or permanently. The storage 140 stores, for example, a machine learning model M (parameters), constraint conditions, fitness, product data, and information of individuals.

The input/output unit 150 enables inputting or outputting of various types of input data from or to other devices.

The display controller 138 may output various types of display data to other devices (such as another display device or a terminal device of a user) via the input/output unit 150 instead of outputting the display data to the display 160.

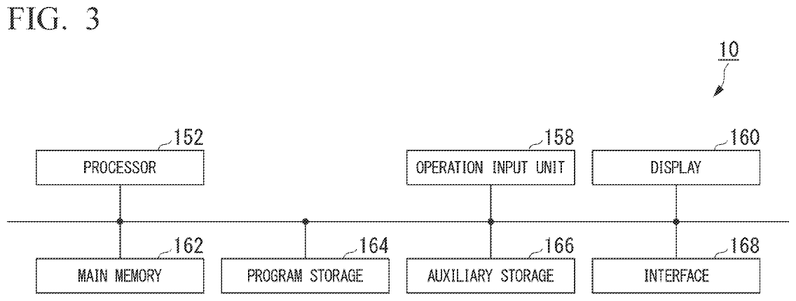

An example of a hardware configuration of the design support device 10 according to the embodiment will be described below. FIG. 3 is a block diagram schematically showing an example of a hardware configuration of the design support device 10 according to the embodiment. The design support device 10 includes, for example, a processor 152, an operation input unit 158, a display 160, a main memory 162, a program storage 164, an auxiliary storage 166, and an interface 168. The processor 152, the operation input unit 158, the display 160, the main memory 162, the program storage 164, the auxiliary storage 166, and the interface 168 are connected to each other via a bus such that various types of data can be input from and output to each other.

The processor 152 performs an arithmetic process instructed by command described in various programs. The processor 152 controls the operations of the design support device 10 as a whole. The processor 152 is, for example, a central processing unit (CPU). In the embodiment, performing the arithmetic process instructed by commands described in a program may be referred to as “executing a program” or the like.

The operation input unit 158 receives a user's operation, generates an operation signal in response to the received operation, and outputs the generated operation signal to the processor 152. Various types of operation information are instructed by the operation signal. The operation input unit 158 may include general members such as a mouse, a touch sensor, and a keyboard or may include dedicated members such as a button or a dial.

The display 160 displays a display screen on the basis of display data input thereto. The display 160 may be one of a liquid crystal display and an organic electroluminescence display.

The main memory 162 is a writable memory that is used as an area for reading an execution program of the processor 152 or a work area for writing process data of the execution program. The main memory 162 includes, for example, a random access memory (RAM).

The program storage 164 stores system firmware such as basic input output system (BIOS), firmware for various devices, other programs, and setting information required to execute the programs. The program storage 164 includes, for example, a read only memory (ROM).

The auxiliary storage 166 permanently stores various types of data and programs in a rewritable manner. The auxiliary storage 166 may be, for example, one of a hard disk drive (HDD) and a solid state drive (SSD).

The interface 168 is connected to another device in a wired or wireless manner such that various types of data can be input or output via a network. The interface 168 includes one or both of an input/output interface and a communication interface.

The processor 152 and the main memory 162 correspond to minimal hardware used to realize a computer system of the design support device 10. The processor 152 mainly realizes the function of the arithmetic processor 120 by executing a predetermined program in cooperation with the main memory 162 and other hardware. The main memory 162, the program storage 164, and the auxiliary storage 166 realize the main function of the storage 140. The interface 168 realizes the main function of the input/output unit 150.

### <Process Flow>

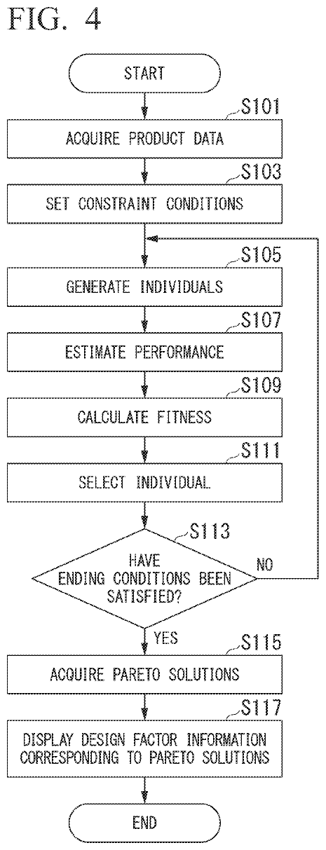

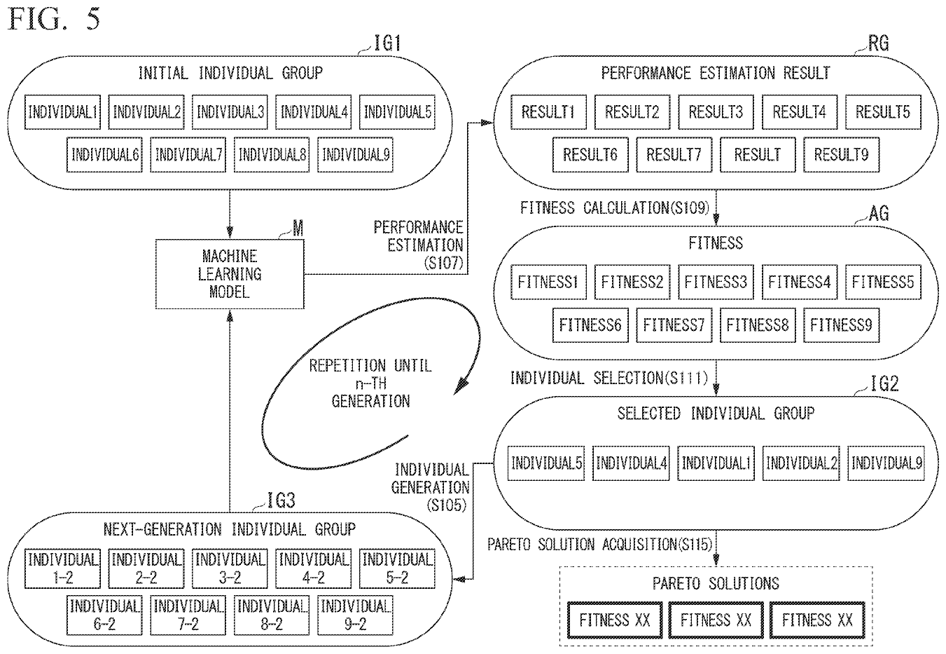

A process flow that is performed by the design support device 10 will be described below. FIG. 4 is a flowchart showing an example of a process flow that is performed by the design support device 10 according to the embodiment. FIG. 5 is a diagram showing an example of data that is generated through processes performed by the design support device 10 according to the embodiment. The process flow shown in FIG. 4 is started, for example, when a user inputs an instruction to start a design process via the operation input unit 158 of the design support device 10.

First, the acquirer 122 acquires product data from an external device such as a product database (Step S101). Alternatively, product data may be stored in a detachable storage medium such as a USB, a DVD, or a CD-ROM, and the acquirer 122 may acquire the product data by setting the storage medium into a drive device of the design support device 10. The product data includes a plurality of data sets which are sets of explanatory variables indicating materials or design items of a product and objective variables indicating performance of the product.

Then, the constraint condition setter 124 sets constraint conditions on the basis of an instruction input from a user via the operation input unit 158 (Step S103). The constraint conditions include, for example, materials of members (material design) used for production of a product, mixture ratios (production-engineering design) of a plurality of types of materials, and a shape. Accordingly, a design factor group satisfying the constraint conditions based on characteristics of the product is defined.

Then, the individual generator 130 generates a plurality of individuals (an initial individual group) corresponding to chromosome information (Step S105). Here, the individual generator 130 generates an initial individual group of a first generation. In this case, the individual generator 130 generates the initial individual group on the basis of the product data acquired by the acquirer 122 and/or the constraint conditions set by the constraint condition setter 124. For example, the individual generator 130 generates a plurality of individuals having values which are between upper limits and lower limits of design factors in the acquired product data and which satisfy the set constraint conditions as the initial individual group. The plurality of individuals have different design factors. In the example shown in FIG. 5, nine individuals (individuals 1 to 9) are generated as the initial individual group IG1. The number of generated individuals can be arbitrarily set.

Then, the performance estimator 126 estimates a plurality of types of performance for each individual group generated by the individual generator 130 using a trained machine learning model M stored in the storage 140 (Step S107). In the example shown in FIG. 5, the performance estimator 126 acquires performance estimation results RG (results 1 to 9) corresponding to the individuals by inputting the individuals (the design factor groups) of the initial individual group IG1 to the machine learning model M.

Then, the fitness calculator 132 calculates fitness of the plurality of types of performance corresponding to the individuals on the basis of the performance estimation results RG estimated by the performance estimator 126 (Step S109). In the example shown in FIG. 5, the fitness calculator 132 calculates the fitness AG (fitness levels 1 to 9) of the plurality of types of performance corresponding to the individuals.

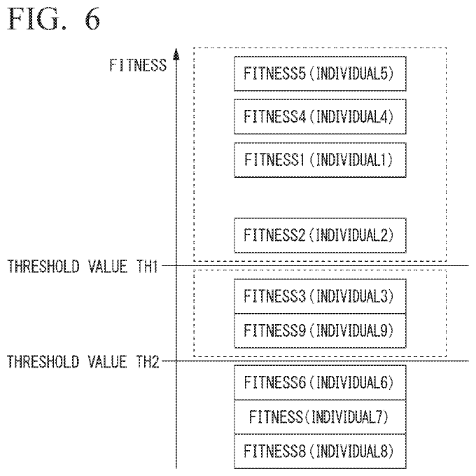

Then, the selector 134 selects candidates (a population) for a next-generation individual group out of the individual group IG1 on the basis of the fitness AG calculated by the fitness calculator 132 (Step S111). FIG. 6 is a diagram showing an individual selecting process based on the fitness according to the embodiment. In the example shown in FIG. 6, the fitness calculated by the fitness calculator 132 decreases in the order of “fitness 5 (individual 5),” “fitness 4 (individual 4),” “fitness 1 (individual 1),” “fitness 2 (individual 2),” “fitness 3 (individual 3),” “fitness 9 (individual 9),” “fitness 6 (individual 6),” “fitness 7 (individual 7),” and “fitness 8 (individual 8).” The selector 134 selects the candidates (a population) for a next-generation individual group, for example, on the basis of a result of comparison between the fitness and a predetermined threshold value. For example, the selector 134 selects individuals with fitness equal to or greater than a threshold value TH1 (individual 5, individual 4, individual 1, and individual 2) as candidates for a next-generation individual group. An individual with fitness equal to or greater than the threshold value TH1 is selected as an “excellent” evaluated individual which has sufficiently high fitness and which is to be kept for a next generation.

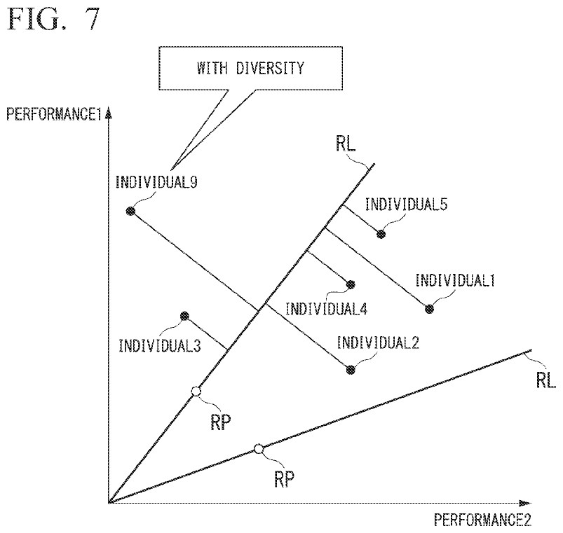

The selector 134 selects an individual with diversity of performance as a candidate (a population) for a next-generation individual group out of individuals (individual 3 and individual 9) with fitness less than the threshold value TH1 and equal to or greater than a threshold value TH2 (threshold value TH2<threshold value TH1). The individual with fitness less than the threshold value TH1 and equal to or greater than the threshold value TH2 can be considered to be “acceptable” evaluated individual which has not sufficiently high fitness and which is a candidate to be kept for a next generation. FIG. 7 is a diagram showing an individual selecting process in consideration of diversity according to the embodiment. For example, a multi-objective optimization approach (NSGA-III) is used. With this approach, by setting a solution search direction (reference line) in advance, high convergence properties can be realized even when objective variables (a plurality of types of performance) are high-ordered. In the example shown in FIG. 7, an individual in an area designated by a user is defined as a reference point (RP), and a direction connecting the origin and the reference point (RP) is set as a reference line (RL). The selector 134 calculates an orthogonal distance of a vector between each individual and the set reference line (RL) and selects an individual with the largest orthogonal distance (individual 9) which is determined as an individual with diversity as a candidate for a next-generation individual out of individuals (individual 3 and individual 9) with fitness less than the threshold value TH1 and equal to or greater than the threshold value Th2. That is, the individual with the largest orthogonal distance (individual 9) can be said to be an individual with diversity such as higher performance 1 and lower performance 2 than those of the “excellent” evaluated individual group (individual 5, individual 4, individual 1, and individual 2). By leaving the individual including outliers (individual 9) in the “excellent” evaluated individual group (individual 5, individual 4, individual 1, and individual 2), it is possible to prevent plunging into a local solution. As a result, in the example shown in FIG. 5, individual 5, individual 4, individual 1, individual 2, and individual 9 are selected as the selected individual group IG2.

In the aforementioned example, two threshold values are used, but the present invention is not limited thereto. For example, the selector 134 may select an individual with fitness in the vicinity of one threshold value (in a predetermined range therefrom) using the one threshold value in view of diversity. The selector 134 may not use a threshold value, select a predetermined number of individuals with higher fitness (for example, three high-ranked individuals) as the “excellent” evaluated individuals, and additionally select a predetermined number of individuals (for example, two individuals) subsequent to the “excellent” evaluated individuals as “acceptable” evaluated individuals in view of diversity.

Then, the generator 128 determines whether ending conditions have been satisfied (Step S113). The ending conditions include, for example, the number of generations (for example, 10 generations). The generator 128 determines that the ending conditions have not been satisfied when processing of individual groups of the first to ninth generations has been completed and determines that the ending conditions have been satisfied when processing of the individual group of the tenth generation has been completed. Here, since processing of the individual group of the first generation has been completed, the generator 128 determines that the ending conditions have not been satisfied (Step S113: NO) and returns the process flow to Step S105.

Then, the individual generator 130 generates an individual group of a next generation (Step S105). When individuals of the second generation or generations subsequent thereto are generated, the individual generator 130 generates an individual group by causing crossing-over or mutation of explanatory variables in the individual group selected by the selector 134. In the example shown in FIG. 5, the individual generator 130 generates 9 individuals (individuals 1-2 to 9-2) as the individual group IG3 of the second generation. The number of generated individuals may the same as that of the initial individual group or may be set to an arbitrary different value.

Thereafter, the performance estimating process (Step S107), the fitness calculating process (Step S109), the individual selecting process (Step S111), and the ending condition determining process (Step S113) are repeatedly performed.

When it is determined that the ending conditions have been satisfied (Step S113: YES), the Pareto solution acquirer 136 acquires a plurality of types of performance corresponding to a predetermined number of individuals with high fitness as Pareto solutions out of the individuals of the n-th generation (the tenth generation) satisfying the ending conditions (Step S115).

Then, the display controller 138 causes the display 160 to display the Pareto solutions and design factor information (candidates for design information) corresponding to the Pareto solutions (Step S117). A user can ascertain a design factor group appropriate for product design by ascertaining the candidates for design information displayed on the display 160. Consequently, the process flow of the flowchart ends.

As described above, the design support device 10 according to the embodiment includes a performance estimator configured to estimate a plurality of types of performance of a product from a design factor group including a plurality of design factors of the product using a machine learning model and a generator configured to generate candidates for design information of the product on the basis of comprehensive evaluation of the estimated plurality of types of performance. The generator includes a Pareto solution acquirer configured to acquire Pareto solutions to the plurality of types of performance as the candidates for design information using a genetic algorithm with the plurality of design factors as chromosome information. Accordingly, it is possible to support optimization of product design.

While an embodiment of the present invention has been described above with reference to the drawings, no specific configuration is limited to the above description. Various design modifications or the like are possible without departing from the gist of the invention.

What is claimed is:

1. A design support device comprising a processor configured to execute a program to:
estimate a plurality of types of performance of a product from a design factor group including a plurality of design factors of the product using a machine learning model; and
generate candidates for design information of the product on the basis of comprehensive evaluation of the estimated plurality of types of performance,
wherein the processor is further configured to execute the program to acquire Pareto solutions to the plurality of types of performance as the candidates for design information using a genetic algorithm with the plurality of design factors as chromosome information.

2. The design support device according to claim 1, wherein the processor is further configured to execute the program to:
calculate fitness indicating the comprehensive evaluation on the basis of the estimated plurality of types of performance; and
acquire the Pareto solutions on the basis of the calculated fitness.

3. The design support device according to claim 2, wherein the processor is further configured to execute the program to select the design factor group of a next generation from a plurality of the design factor groups of a certain generation on the basis of the calculated fitness.

4. The design support device according to claim 3, wherein the processor is further configured to execute the program to select a design factor group including outliers in the plurality of types of performance as the design factor group of the next generation from the plurality of design factor groups of the certain generation.

5. The design support device according to claim 3, wherein the processor is configured to execute the program to generate the design factor group of the next generation by causing at least one of crossing-over and mutation in the selected design factor group.

6. The design support device according to claim 2, wherein the processor is configured to execute the program to calculate the fitness by summing numerical values of the estimated plurality of types of performance.

7. The design support device according to claim 2, wherein the processor is configured to execute the program to calculate the fitness by summing values obtained by multiplying numerical values of the estimated plurality of types of performance by weights.

8. The design support device according to claim 1, wherein the processor is configured to execute the program to estimate the plurality of types of performance from the design factor group satisfying constraint conditions based on characteristics of the product.

9. The design support device according to claim 1, wherein the machine learning model is a model that is trained to output estimated values of the plurality of types of performance when the design factor group is input.

10. The design support device according to claim 1, wherein the product is a battery.

11. A design support method that is performed by a computer, the design support method comprising:
estimating a plurality of types of performance of a product from a design factor group including a plurality of design factors of a product using a machine learning model; and
generating candidates for design information of the product on the basis of comprehensive evaluation of the estimated plurality of types of performance,
wherein the generating of candidates for design information of the product includes acquiring Pareto solutions to the plurality of types of performance as the candidates for design information using a genetic algorithm with the plurality of design factors as chromosome information.

12. A non-transitory computer-readable storage medium storing a program for causing a computer to perform:
estimating a plurality of types of performance of a product from a design factor group including a plurality of design factors of a product using a machine learning model; and
generating candidates for design information of the product on the basis of comprehensive evaluation of the estimated plurality of types of performance,
wherein the generating of candidates for design information of the product includes acquiring Pareto solutions to the plurality of types of performance as the candidates for design information using a genetic algorithm with the plurality of design factors as chromosome information.
